(19) United States
(12) Patent Application Publication
(10) Pub. No.: US 2024/0223027 A1
(43) Pub. Date: Jul. 4, 2024

(54) STATOR FOR AN ELECTRIC MACHINE, ELECTRIC MACHINE, STATOR COOLING SYSTEM, AND METHOD FOR COOLING A STATOR

(71) Applicant: ADDITIVE | DRIVES GMBH, Dresden (DE)

(72) Inventor: Markus OETTEL, Dresden (DE)

(21) Appl. No.: 18/563,743

(22) PCT Filed: May 27, 2022
(86) PCT No.: PCT/EP2022/064392

§ 371 Date: Nov. 22, 2023

(30) Foreign Application Priority Data
May 27, 2021 (DE) 10 2021 113 663.6
Jul. 27, 2021 (DE) 10 2021 119 405.9

(51) Int. Cl. H02K 1/16; B33Y 80/00; H02K 3/24; H02K 3/28; H02K 11/25

(52) U.S. Cl. CPC H02K 1/16; B33Y 80/00; H02K 3/24; H02K 3/28; H02K 11/25

(57) ABSTRACT

Stator for an electrical machine, which has a stator core with at least one stator groove in which at least two electrical conductors are arranged, wherein at least part of the stator is produced by additive manufacturing, wherein for a predetermined number of the electrical conductors in each case at least one cooling channel which can be supplied with a cooling fluid is formed, wherein at least a first and a further cooling channel group, in each of which the cooling channels of several electrical conductors can be supplied with cooling fluid in parallel with one another, are fluidically connected in series and/or in parallel to form separate circuits or one circuit.

The invention relates to a stator for an electric machine, in particular for an electric motor or generator, which has a stator core with at least one stator groove in which at least two (preferably at least four) electrical conductors are arranged, wherein at least a part of the stator is produced by means of a method for additive manufacturing, an electric machine, in particular an electric motor or generator, a stator cooling system as well as a method for cooling a stator.

In electrical machines, the temperature, in particular of the electrical conductors in the stator, is one of the decisive factors for how powerful and/or efficient the electrical machine is in operation.

In particularly powerful motors, high electrical currents flow in the conductors of the electric motor. However, this leads to heat being generated due to the specific resistance of the conductor material. As the heat increases, the resistance of the conductor material in turn increases, so that that the efficiency of the electric motor can deteriorate by several orders of magnitude.

It is therefore necessary to provide a suitable stator cooling for the electric motors, particularly in the field of high-performance motors, which are used in the drivetrains of electric, hybrid or hydrogen cars, for example.

A conventional approach to cooling electric motors is to surround the electrical conductors of the stator of an electric motor with a heat conducting body. By the heat conducting body the waste heat generated in the electrical conductors can be conducted away from the stator. Additionally, in the state of the art, cooling jackets are also provided around the heat conducting body, which can be designed as heat exchangers with coolant flowing through them. The heat conducting bodies are designed as laminated sheet packages, for example.

With this conventional approach, however, the waste heat generated is conducted from the electrical conductors via the heat conducting body to the cooling jacket. Such an approach therefore only offers very indirect and/or sluggish cooling of the electrical conductors of the stator and is therefore dependent on the thermal conductivity of the heat conducting body.

A direct cooling of the electrical conductors is therefore desirable. In DE 10 2014 201 305 A1, an approach for a direct cooling of a winding conductor of a waveguide coil is pursued. The waveguide coil is provided with a cooling channel along the entire length of the winding conductor.

However, this leads to the fact that when coolant is applied to such a waveguide coil, the flow resistance for the coolant can be very high depending on the length of the winding conductor and the radius of the channel provided in the winding conductor, by which, inter alia, the choice of coolant (with regard to the viscosity properties of the coolant) is influenced.

In addition, the technical complexity and the technical requirements of the system intended for pressurisation increase, as, due to the increased flow resistance, the coolant must be pressurised at a higher pressure in order to let the coolant flow through the channel of the waveguide coil.

Furthermore, the production of this waveguide coil is considerably more complicated. Because forming and bending processes lead to constriction and thus a reduction of the channel in the waveguide. In addition, due to the provision of the channel over the entire length of the winding conductor a loss of installation space in all regions of the channel occurs, because of which the fill factor of the winding conductor in the stator groove is reduced and thus the achievable power of the electric motor decreases.

It is therefore the object of the invention to propose a stator for an electric machine, an electric machine, a stator cooling system and a method for cooling a stator, wherein a cooling as effective as possible of the electrical conductors of the stator of an electric machine should be achieved, in particular a design as space-saving as possible should be achieved, which is characterised by a high performance and/or a high efficiency in operation.

This object is solved in particular by the subject matter according to claim 1. Furthermore, the problem is solved in particular by the subject matter according to claims 23, 24 and 26.

In particular, the object is solved by a stator for an electrical machine (in particular for an electric motor or generator), which has a stator core with at least one stator groove in which at least two (preferably at least four) electrical conductors are arranged, wherein at least a part of the stator is produced by means of a method for additive manufacturing, wherein with a predetermined number of the electrical conductors at least one cooling channel which can be supplied with a cooling fluid is formed in each case, wherein at least two or at least four cooling channels that are not formed by the same electrical conductor are fluidically connected in parallel and/or wherein at least four or at least six or at least eight or at least ten cooling channels (which can be assigned to the same or different cooling channels) are fluidically connected in parallel, and/or wherein at least one first and one further cooling channel group, in each of which the cooling channels of several electrical conductors can be supplied with cooling fluid in parallel to one another, are fluidically connected in series and/or in parallel to form separate circuits or one circuit.

The electrical conductors can be designed in particular as individual winding conductors of a winding, preferably as individual winding conductors of a coil, further preferably as Ipins (or rod-shaped conductors) or Upins (or U-shaped conductors) or hairpins. It is preferred that the stator core has a plurality of stator grooves as well as a plurality of electrical conductors accommodated in the stator grooves.

A core idea of the invention is to provide at least a predetermined number of the (individual) electrical conductors of a stator with cooling channels and to supply the cooling channels of the electrical conductors in a parallel circuit or in several parallel circuits with cooling fluid. This enables a direct cooling of the electrical conductors. The cooling channels of the electrical conductors of the stator can be formed directly in or in the immediate vicinity of the electrical conductors by using an additive process to manufacture at least part of the stator.

Additive deposition or manufacturing is understood in particular to mean the manufacturing by means of a 3D printing, in particular a 3D copper printing, and/or by means of an additive printing process and/or a master moulding process. The elements and/or connections of at least one winding head of the stator are preferably produced by means of the method for additive manufacturing, in particular in one piece and/or directly in their final form, in particular by applying build-up material layer by layer and preferably a selective solidification, preferably by means of a beam impinging thereon, for example a laser beam.

In particular, the additive manufacturing is carried out by applying build-up material layer by layer, preferably by a selective solidification, preferably by means of a beam impinging thereon, for example by means of a laser beam.

Additive deposition or additive manufacturing is preferably understood to mean a layer-by-layer deposition of a component on an existing, prefabricated component, without the use of welded joints, in particular without the use of welded joints between two or more prefabricated components, and/or forming tools and/or tools in general. A layer-by-layer application means, in particular, the creation or manufacture of a component by layer-by-layer application to another existing component.

Preferably, at least one winding head of the stator is produced or manufactured by means of a single production, manufacturing, working or process step, in particular additively.

Preferably, the additive application or additive manufacturing is carried out on the basis of data sets that define the respective geometries. These data sets are preferably generated in the design and/or by a CAD or CAE programme. These data sets then control a 3D printing system that additively, in particular layer by layer, applies the build-up material and preferably selectively solidifies it, and thus produces at least one section of the at least one winding head and/or of the active region, in particular of the laminated sheet package.

One and the same active region, in particular one and the same stator blank or stator core, can thus be given a different behaviour (for example with regard to torque and/or speed, etc.) by different connexion. This makes it possible to develop a construction kit that can produce a plurality of different electric motors on the basis of on one stator blank or stator core (by combining the same stator blank or stator core with different printed winding heads). This different connexion is preferably produced exclusively digitally, in the design, in particular by variation of data sets for the additive application, and/or without the use of physical tools. The data sets are preferably generated using a CAD or CAE programme.

As raw or build-up material(s) for additive manufacturing, in particular aluminium materials or aluminium powder, copper materials or copper powder, in particular pure copper, pure aluminium, aluminium alloys or copper alloys are used. Preferably, the copper materials or copper powders used have a purity of more than 99.5%.

High-purity copper and/or high-purity aluminium preferably offer good electrical and thermal conductivity. Preferably, the tensile strength is at least 170 MPa and/or the yield strength is at least 120 MPa and/or the elongation at break is more than 20%.

In one embodiment, the cooling channels of the first cooling channel group and of the further cooling channel group are connected in parallel within the groups, wherein the first cooling channel group is connected in series with the further cooling channel group, so that in particular an inlet volume flow and an outlet volume flow are connected to form a cooling circuit.

In one embodiment, the ratio between the predetermined number of conductors, in each of which at least one cooling channel which can be supplied with a cooling fluid is formed, and a number of conductors in the at least one stator groove is ¼ or at most ¼.

In one embodiment, the cooling channels are distributed over the electrical conductors in such a way that one cooling channel is provided in an inner region in relation to the or a radial direction of the stator, two cooling channels are provided in a middle region in relation to the radial direction of the stator and one cooling channel is provided in an outer region in relation to the radial direction of the stator, wherein the outer region in particular adjoins the middle region in the direction of an outer circumference of the stator, wherein the outer region in particular comprises two electrical conductors.

In one embodiment, the cooling channels are distributed over the electrical conductors in such a way that the electrical conductors are provided alternately, in particular alternatingly, with a cooling channel and without a cooling channel or not with a cooling channel in the radial direction of the stator from an inner circumference to an outer circumference of the stator, wherein in particular the innermost electrical conductor in an inner region in relation to the radial direction of the stator is provided with a cooling channel.

In one embodiment, at least one winding head of the stator is manufactured by means of the method for additive manufacturing, in particular additively applied to a non-additively manufactured stator core or active region of the stator.

In one embodiment, at least one connection element of at least one cooling channel element is produced by means of the method for additive manufacturing, wherein in particular the connection element is produced in a manufacturing step together with at least one winding head of the stator and/or at least one electrical conductor by means of the method for additive manufacturing, in particular in the same manufacturing step.

In one embodiment, at least one winding head of the stator is additively manufactured in one piece and/or directly in its final form, in particular additively applied to a stator core or active region of the stator.

In at least one embodiment, at least one winding head of the stator comprises at least one connection element for at least one cooling channel element.

In at least one embodiment, the stator comprises at least one winding head.

In at least one embodiment, the stator comprises two winding heads, in particular on a first and second face side of a stator core or active region of the stator.

In at least one embodiment, the stator comprises a stator core, preferably comprising a laminated sheet package and/or the at least one stator groove or several stator grooves, wherein at least two (preferably at least four) electrical conductors are arranged in the at least one stator groove or in each stator groove. Preferably, the stator core comprises the or an active region.

By connecting the cooling channels of the electrical conductors in parallel, a reduction in the flow resistance is achieved and the cooling power is provided specifically where the heat or waste heat is generated in the stator.

It is possible that the cooling channels connected in parallel are connected to separate circuits (cooling circuits), for example to increase the cooling capacity with which the electrical conductors are cooled, or are connected to one circuit (cooling circuit), for example in addition to increasing the cooling capacity to distribute it as efficiently as possible to the electrical conductors of the stator.

Under a cooling fluid can be understood a gaseous or liquid substance or a mixture of substances that can be used to remove heat.

Preferably, the predetermined number of electrical conductors at which a cooling channel is formed is less than or equal to a number of conductors in the at least one stator groove. In particular, a ratio between a number of cooling channels (a number of the electrical conductors provided with a cooling channel) and the number of conductors is less than 1, preferably less than ¾, more preferably less than ½. In particular, the ratio is less than ¼.

This leads to the fact that if the number of electrical conductors is smaller than the number of conductors, not every electrical conductor is provided with a cooling channel, by which a higher fill factor of the stator groove can be achieved. In this way, a more compact design of the stator and a high performance of the electric motor can be achieved.

In addition, a compromise can be achieved by this between the cooling capacity with which the electrical conductors of the stator groove can be cooled and the fill factor.

The electrical conductors of a stator groove are arranged in particular in a cross-section (perpendicular to a central axis of the stator) in a radial direction of the stator, whereby the electrical conductors, which are arranged in an inner region in relation to the radial direction of the stator, are formed with cooling channels. By this it is possible to introduce cooling capacity directly where the heat development in the stator groove is greatest.

Additionally or alternatively, the electrical conductors, which are arranged in an outer region in relation to the radial direction of the stator and/or in a middle region between the outer and inner region, can be formed with cooling channels. The central axis of the stator is preferably an axis around which the stator is arranged hollow-cylindrically, whereby the stator groove(s) is/are formed by recesses in the stator core that run in the radial and axial direction of the stator. The stator groove(s) can be open towards an inner circumference of the stator or towards an outer circumference of the stator.

In one embodiment, the electrical conductors formed with at least one cooling channel are formed as hollow channel conductors whose cooling channel extends along a longitudinal direction of the electrical conductor. The hollow channel conductors can have an annular cross-section, preferably a rectangular or polygonal cross-section with a circular, rectangular or polygonal cross-section of the cooling channel.

The design of the electrical conductors as hollow channel conductors makes it possible to cool the electrical conductors, which contribute significantly to heat generation in the stator, directly by supplying cooling fluid to the cooling channels formed in the electrical conductors.

In a further embodiment, the electrical conductors formed with a cooling channel can each have a (tubular or hose-shaped) cooling channel element that forms the cooling channel and can be supplied with cooling fluid.

The cooling channel elements are preferably formed to be fluid-tight. In particular, the cooling channel elements are made of a material with a lower electrical conductivity (for example, lower than copper) and/or with a high thermal conductivity.

In particular, the cooling channel elements can be made of an inert material, such as plastic, which enables the use of water as cooling fluid. Preferably, the material is an electrical insulator with good thermal conductivity.

It is preferred that the cooling channel elements in an active region of the stator are at least partially, preferably completely, enclosed by the respective electrical conductor, whereby the heat transfer surface between the electrical conductor and cooling channel element can be increased, particularly in the active region, and thus an improved heat dissipation can be achieved. Alternatively or additionally, at least one cooling channel (possibly several or all cooling channels) may not (possibly not even partially) be enclosed by the respective (associated) electrical conductor.

Alternatively or additionally, at least one cooling channel (possibly several or all cooling channels) can be arranged next to, in particular directly next to one or more conductors (in particular between two or more conductors in each case).

A length of the (respective) cooling channel can be at most 3 times or at most 2 times or at most 1.5 times or at most 1.2 times as long as a length of the corresponding stator groove (in which the respective cooling channel runs).

An active region of the stator (or the electrical conductors, in particular the windings) is to be understood in particular as an annular section of the stator in which the electrical conductors run parallel to a central axis of the stator. In the (respective) active region the actual power generation of the electric motor preferably takes place, as the required (magnetic) rotating field is generated here in order to (rotationally) move a rotor (arranged within the stator).

The cooling channel elements in a first (upper) and a second (lower) head region (winding head) of the stator are in particular at least partially enclosed by the respective electrical conductor, whereby the heat transfer surface between the electrical conductor and the cooling channel element can be increased all the way into the first and second head region (winding head) of the stator and thus a further improvement in heat dissipation can be achieved.

Under a first head region of the stator is preferably to be understood a section of the stator that (at the top) connects to the active region (or the force-generating region).

In the first head region, the electrical conductors do not run parallel to the central axis of the stator. Under a second head region of the stator is to be understood in particular a corresponding section that connects to the other side of the active region (at the bottom), i.e. in the axial direction of the stator on the opposite side of the stator.

The cooling channel elements and the associated electrical conductors preferably branch out in the first and in the second head region of the stator, whereby a continuation or (electrical) contacting of the electrical conductor as well as a fluidic coupling of the cooling elements in the first and/or second head region ins enabled.

It is preferred that each cooling channel element can be fluidically coupled at a first end in the first head region and at a second end in the second head region by means of a connection element, whereby the fluidic coupling of the cooling elements in the first and second head region is facilitated.

The cooling channel elements associated with an electrical conductor are arranged in particular next to the electrical conductor, so that at least part of a wall of the cooling channel element is adjacent to the associated electrical conductor, whereby the cross-section of the electrical conductor can be increased and at the same time a good heat transfer between the cooling channel element and the electrical conductor is achieved.

Preferably, the cooling channel element associated with an electrical conductor is additionally arranged next to a neighbouring electrical conductor, so that at least a part of the wall of the cooling channel element is adjacent to the associated electrical conductor and to the neighbouring electrical conductor, whereby a cooling channel element can provide cooling capacity for both the associated electrical conductor as well as the neighbouring electrical conductor.

The above-mentioned object is further solved by an electric machine (in particular an electric motor or generator) for an electrically or hybrid-electrically driven vehicle, which machine has a stator of the above type and a rotor.

The above object is further solved by a stator cooling system, comprising: an electric machine of the above type;
a cooling unit which is fluidically coupled to the cooling channels of the electrical conductors of the stator of the above type in such a way that the first and the further cooling channel group are fluidically connected to form separate circuits or to form one circuit in series and/or in parallel, wherein the cooling unit is further formed to supply the circuits or the circuit with a cooling fluid.

Preferably, the stator cooling system also has the following:
a sensor unit which is formed to detect at least one temperature of the electrical conductors of the stator;
a control unit which is communicatively connected to the sensor unit and the cooling unit and is formed to control the cooling unit in such a way that the temperature of the electrical conductors of the stator below a predetermined lower limit temperature or above a predetermined upper limit temperature, is preferably approached to a set-point temperature.

It is preferred that the temperature of the electrical conductors is controlled at least essentially to a set-point temperature (preferably constant).

Additionally or alternatively, a temperature of the cooling fluid in a flow and/or in a return of the circuit or circuits can be detected and transmitted to the control unit.

Preferably, the temperature(s) of the cooling fluid is/are used in the control unit to control the temperature of the electrical conductors of the stator.

The above object is further solved by a method for cooling the electrical conductors of a stator of the above type with a stator cooling system of the above type, wherein the circuit or circuits that is/are formed by the cooling channels is/are supplied with a cooling fluid in such a way that the temperature of the electrical conductors of the stator below a predetermined lower limit temperature or above a predetermined upper limit temperature is preferably approached to a set-point temperature.

In the method for cooling the electrical conductors, in particular the temperature of the electrical conductors is controlled at least essentially to a set-point temperature (preferably constant).

The further aspects explained below can preferably be combined with the above aspects or features.

A further aspect is to maintain the temperature of the electrical conductors of a stator in a certain range in which the electrical machine can be operated efficiently. This can also include, for example, a heating (instead of a cooling) of the electrical conductors of the stator when the electrical machine is operated at low temperatures, for example as a generator.

Further embodiments of the invention result from the dependent claims.

The invention is described below with reference to execution examples, which are explained in more detail with reference to the figures. These show:

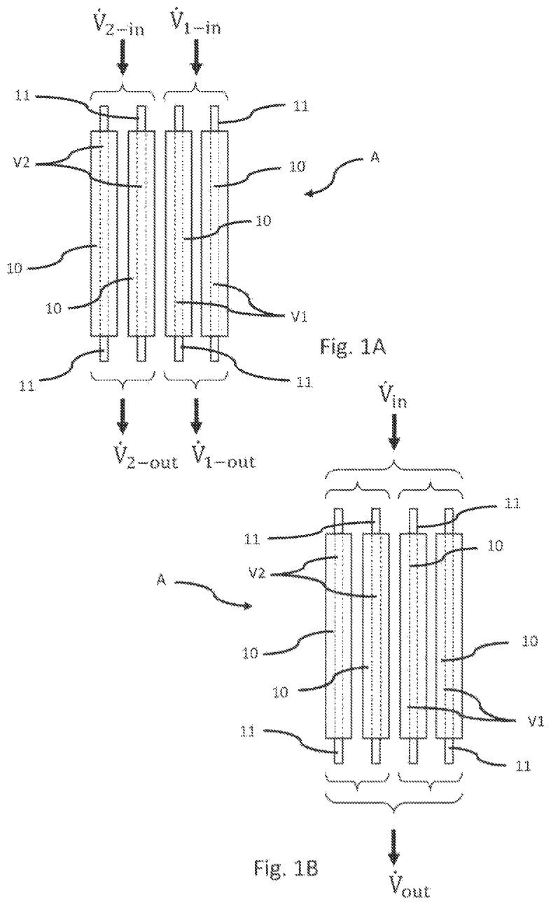

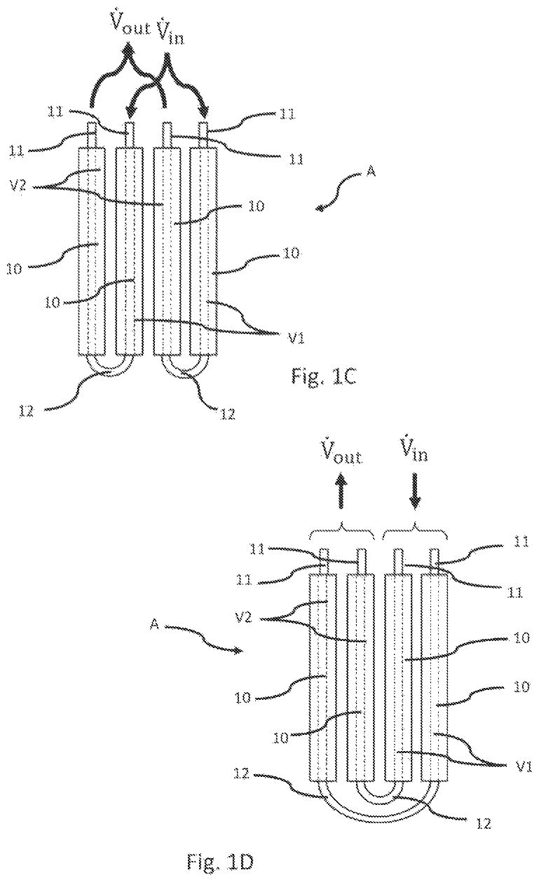

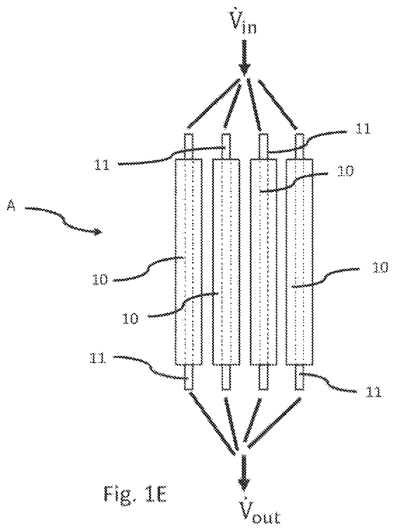

FIGS. 1A-1E several schematic longitudinal sections of the electrical conductors in the active region of different execution examples;

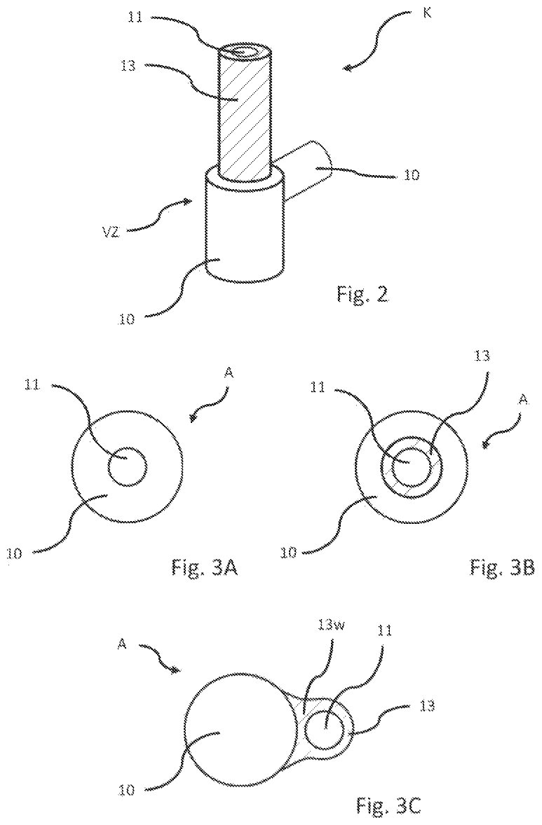

FIG. 2 a a three-dimensional view of an execution example of a cooling channel element with an electrical conductor;

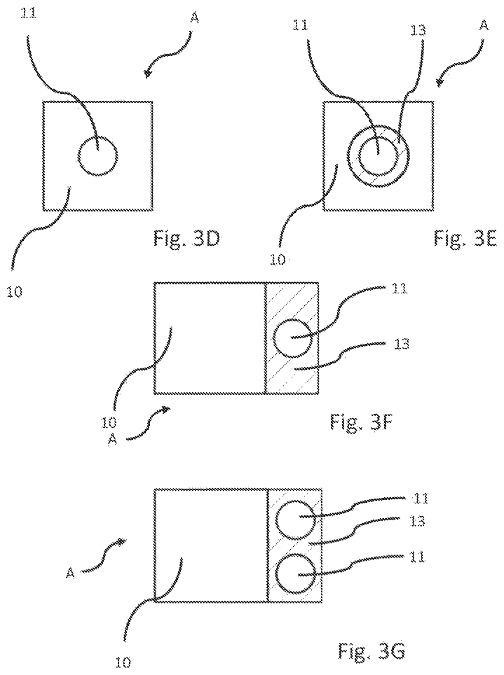

FIG. 3A-3G several schematic cross-sections of the electrical conductors in the active region of execution examples according to the invention;

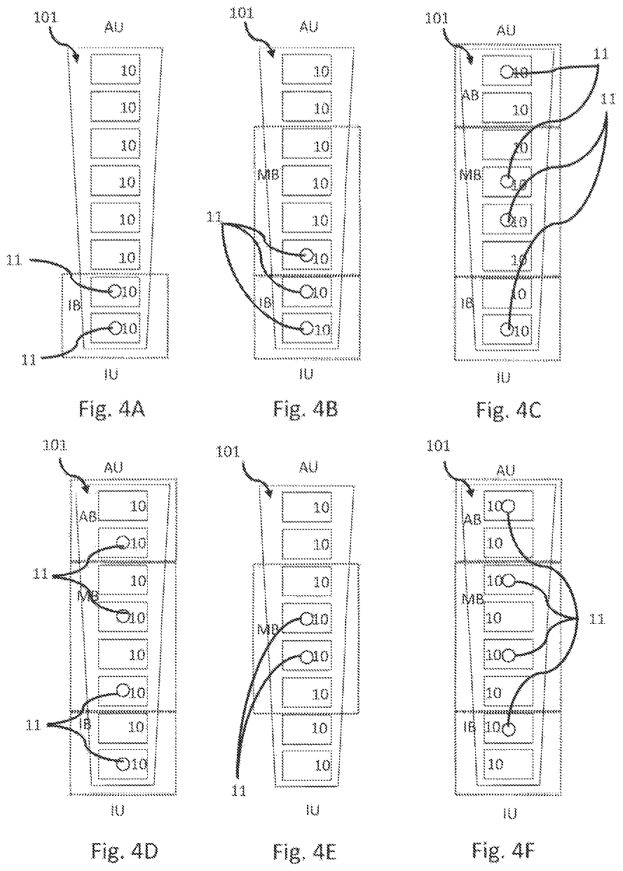

FIG. 4A-4F different schematic cross-sections of the stator groove in the active region of different execution examples;

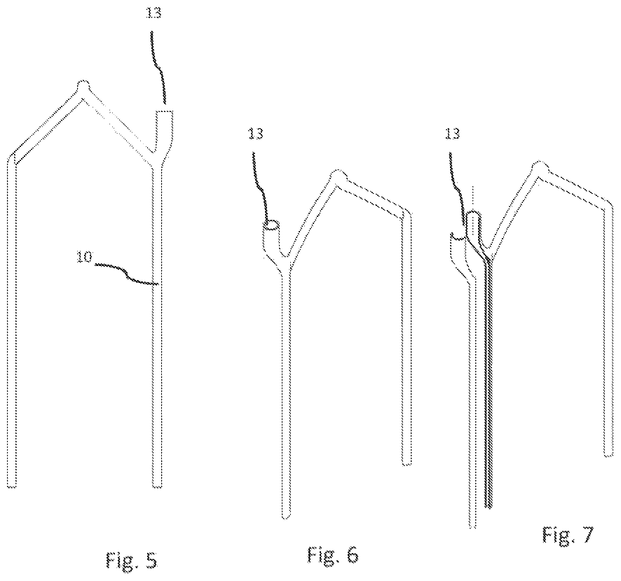

FIG. 5 a U-shaped conductor with cooling channel in a side view of;

FIG. 6 the conductor according to FIG. 5 in an oblique view of;

FIG. 7 the conductor according to FIG. 5 with partially visible interior;

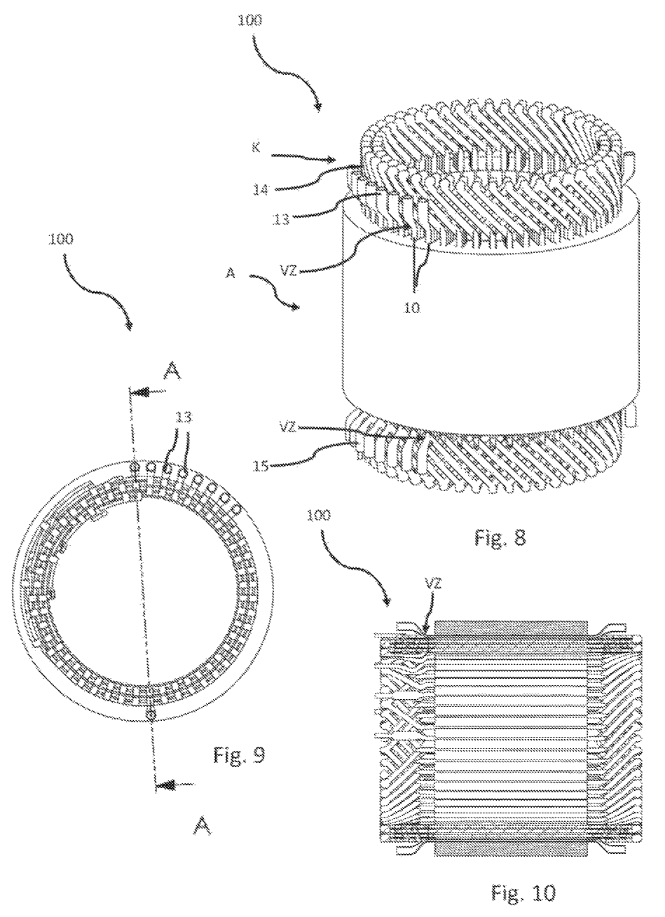

FIG. 8 a stator according to the invention with cooling channels;

FIG. 9 a cross-section (transverse to the longitudinal direction) through the stator according to FIG. 8;

FIG. 10 a sectional view along line A-A from FIG. 9.

In the following description, the same reference numbers are used for same and similarly acting parts.

FIG. 1A shows a schematic longitudinal section of the active region A of a stator 100.

Four electrical conductors 10 are shown, which are formed as Ipins (rod-shaped conductors). A cooling channel 11 is formed in each of the individual electrical conductors 10.

The cooling channels 11 of the electrical conductors 10 of a first cooling channel group V1 are connected in parallel and are supplied with cooling fluid in parallel by a first inlet flow rate \dot{V}₁₋ᵢₙ. The first outlet volume flow \dot{V}₁₋ₒᵤₜ of the first cooling channel group V1 is connected together with the first inlet volume flow \dot{V}₁₋ᵢₙ to form a cooling circuit.

The cooling channels 11 of the electrical conductors 10 of a further cooling channel group V2 are also connected in parallel and are supplied with cooling fluid in parallel by a further inlet flow rate \dot{V}₂₋ᵢₙ. The further outlet volume flow \dot{V}₂₋ₒᵤₜ of the further cooling channel group V1 is connected together with the further inlet volume flow \dot{V}₂₋ᵢₙ to form a separate cooling circuit.

In the execution example of FIG. 1A, the cooling channels of the electrical conductors are fluidically connected to form two separate cooling circuits.

FIG. 1B shows a schematic longitudinal section of the active region A of a stator 100, whereby the four electrical conductors 10 are formed as Ipins (rod-shaped conductors) and each have a cooling channel 11.

The cooling channels 11 of the electrical conductors 10 of a first cooling channel group V1 are connected in parallel to each other and the cooling channels 11 of the electrical conductors 10 of a further cooling channel group V2 are connected in parallel to each other.

In this execution example, the cooling channels 11 of a first cooling channel group V1 and the cooling channels 11 of a second cooling channel group V2 are connected in parallel to each other, so that an inlet volume flow \dot{V}ᵢₙ and an outlet volume flow \dot{V}ₒᵤₜ are connected to form a cooling circuit.

FIG. 1C shows a further execution example. The cooling channels 11 of the first cooling channel group V1 and the further cooling channel group V2 are connected in parallel within the groups, whereby the first channel duct group V1 is connected in series with the further cooling channel group V2, so that an inlet volume flow \dot{V}ᵢₙ and an outlet volume flow \dot{V}ₒᵤₜ are connected to form a cooling circuit.

The series connection of the cooling channels 11 of the first and the further cooling channel group V1, V2 is achieved by corresponding cooling channel deflector elements 12.

In FIG. 1D a further execution example is shown in which, as in FIG. 1C, the cooling channels of the first cooling channel group V1 are connected in series with the cooling channels of the further cooling channel group V2, so that an inlet volume flow \dot{V}ᵢₙ and an outlet volume flow \dot{V}ₒᵤₜ are connected to form a cooling circuit.

The series connection of the cooling channels 11 of the first and the further cooling channel group V1, V2 is also achieved here, for example, by corresponding cooling channel deflector elements 12.

In FIG. 1E a further execution example is illustrated in which the (all) cooling channels are connected in parallel to each other and there are not several cooling channel groups.

FIG. 2 shows an exemplary three-dimensional view of an electrical conductor 10 in a head region of the stator 100. In this execution example, a cooling channel element 13 forms a cooling channel 11. In the active region, the cooling channel element 13 is completely enclosed by the electrical conductor 10. In a branching region VZ of the head region K shown, the electrical conductor 10 and the cooling channel element 13, which is enclosed by the electrical conductor 10 at least in the active region of the stator 100, branch out.

In FIGS. 3A to 3H the cross-sections of various execution examples of electrical conductors 10 in the active region A of the stator 100 are illustrated.

FIG. 3A shows the cross-section of a conductor 10 in which the cooling channel 11 is formed directly in the electrical conductor 10. The cross-section of the conductor 10 is annular. In this example, no cooling channel element is provided between the cooling channel 11 and the conductor.

FIG. 3B shows the example from FIG. 3A, but in the electrical conductor 10 a cooling channel element 13 is formed, which separates the cooling channel 11 from the electrical conductor 10. The cross-sections of the conductor 10 and the cooling channel element 13 are annular.

FIG. 3C shows a further execution example in which the electrical conductor 10 is arranged in cross-section next to the cooling channel element 13. In this example, the conductor 10 is adjacent to a part 13w of the wall of the cooling channel element 13, so that heat transfer between the electrical conductor and the cooling channel element is achieved. In this example, the cross-sections of the conductor 10 and the cooling channel element 13 are at least essentially annular, although in part 13w of the wall of the cooling channel element 13, an outer diameter of the cooling channel element 13 continuously approaches the outer diameter of the electrical conductor.

In FIG. 3D, the illustrated cross-section of the conductor 10 is rectangular and the cross-section of the cooling channel is circular. Other polygonal shapes are also conceivable for the cross-section of the conductor 10 or for the cross-section of the cooling channel 11 in order to optimise the fill factor in the stator groove and the flow resistance of the cooling channel.

FIG. 3E shows the example from FIG. 3D, in which in the electrical conductor 10 a cooling channel element 13 is formed, which separates the cooling channel 11 from the electrical conductor 10.

FIG. 3F shows a further execution example in which the electrical conductor 10 is arranged in cross-section next to the cooling channel element 13. The cross-sections of the conductor 10 and the cooling channel element 13 are formed rectangular. In FIG. 3G, two cooling channels are formed in the cooling channel element 13.

In the FIGS. 4A to 4F cross-sections of a stator groove in the active region A in several execution examples are illustrated. In each of the execution examples, the number of electrical conductors 10 which are provided with a cooling channel 11 is less than the number of conductors in the stator groove 101. In this execution example, eight electrical conductors 10 are provided per stator groove 101.

In FIG. 4A, only two of the eight electrical conductors 10 are formed with cooling channels. The electrical conductors 10, which are provided with a cooling channel 11, are located in an inner region IB. In this example, the inner region comprises the innermost two electrical conductors 10, which are arranged closer to the inner circumference IU of the stator 100 than the remaining electrical conductors 10. A ratio between the predetermined number of conductors 10 which are provided with a cooling channel and the number of conductors in the stator groove 101 is ¼.

In FIG. 4B, in addition to the example from 4A, a further electrical conductor 10 of the eight electrical conductors 10 is provided with a cooling channel 11. The additional electrical conductor 10 is arranged in a middle region, which adjoins the inner region in the radial direction and lies further out in the direction of the outer circumference AU of the stator 100. The ratio between the predetermined number of conductors 10, which are provided with a cooling channel, and the number of conductors in the stator groove 101 is ⅜.

FIG. 4C shows an execution example in which four of the eight electrical conductors 10 are formed with a cooling channel 11. The ratio between the predetermined number of conductors 10 which are provided with a cooling channel 11 and the number of conductors in the stator groove 101 is ½.

The cooling channels 11 are distributed over the electrical conductors 10 in such a way that one cooling channel is provided in the inner region IB, two cooling channels 11 in the centre region MB and one cooling channel 11 in an outer region AB. The outer region AB adjoins the middle region MB in the direction of the outer circumference AU of the stator 100. The outer region AB comprises two electrical conductors 10.

FIG. 4D shows an execution example in which four of the eight electrical conductors 10 are formed with a cooling channel 11. The ratio between the predetermined number of conductors 10 which are provided with a cooling channel 11 and the number of conductors in the stator groove 101 is ½.

The cooling channels 11 are distributed over the electrical conductors 10 in such a way that the electrical conductors 10 are provided alternately (i.e. alternatingly) with a cooling channel 11 and without a cooling channel in the radial direction from the inner circumference IU to the outer circumference AU of the stator 100, wherein the innermost electrical conductor 10 in the inner region IB is provided with a cooling channel 11.

FIG. 4E shows an execution example in which two of the eight electrical conductors 10 are formed with a cooling channel 11, so that the ratio between the predetermined number of conductors 10 which are provided with a cooling channel 11 and the number of conductors in the stator groove 101 is ¼. In this example, two electrical conductors 10 in the middle region MB of the stator are provided with cooling channels 11.

FIG. 4F shows the execution example of FIG. 4D, in which the electrical conductors 10 are alternately provided with a cooling channel 11 and without a cooling channel, but wherein the innermost electrical conductor 10, which is provided with a cooling channel 11, is the second innermost electrical conductor 10.

FIGS. 5 to 10 show a stator 100 according to the invention (FIGS. 5 to 7 only show sections). In this execution example, the cooling channel elements 13 in the active region A of the stator 100 are enclosed by the electrical conductors 10. In the upper and lower head regions of the stator 100, the cooling channel elements 13 branch off from the respective electrical conductor 10 (namely in a respective branching region VZ.

Specifically, in the case of hair-pin structures (see FIGS. 5 to 7), a respective cooling channel element 13 can run, for example, through an outer conductor 10 of the hair-pin structure (which is not mandatory). Possibly, no cooling channel element 13 can run through an inner conductor 10 of the hair-pin structure (alternatively or additionally, however, this is possible).

In the embodiment according to FIGS. 5 to 10, (here by way of example: eight; more generally: several, in particular at least two or at least four or at least eight) conductors 10 of the hairpin structure are equipped with exactly one cooling channel element 13. Alternatively or additionally, a respective cooling channel element 13 can also be assigned to an inner conductor section of the respective hair-pin.

In one embodiment, at least one winding head 14, 15 is produced by means of the method for additive manufacturing, in particular additively applied to a non-additively manufactured stator core or active region A of the stator.

In one embodiment, at least one connecting element of at least one cooling channel element 13 is produced by means of the method for additive manufacturing, wherein in particular the connecting element can be produced in one manufacturing step together with at least one winding head 14, 15 by means of the method for additive manufacturing.

In one embodiment, at least one winding head 14, 15 is additively manufactured in one piece and/or directly in its final form, in particular additively applied to a stator core or active region of the stator.

In one embodiment, at least one winding head 14, 15 comprises at least one connecting element for at least one cooling channel element 13.

At this point, it should be pointed out that all of the parts described above are claimed to be essential to the invention when viewed individually and in any combination, in particular the details shown in the drawings. Modifications thereof are familiar to the skilled person.

Furthermore, it is pointed out that a scope of protection as broad as possible is sought. In this respect, the invention defined in the claims can also be specified by features that are described with further features (even without these further features necessarily being included). It is explicitly pointed out that round brackets and the term “in particular” are intended to emphasise the optional nature of features in the respective context (which does not mean, conversely, that a feature is to be regarded as mandatory in the corresponding context without such identification).

### REFERENCE SYMBOL

100 stator
101 stator groove
10 electrical conductor
11 cooling channel
12 cooling channel deflector elements
13 cooling channel element
14, 15 winding head
A active region
K first (upper) and second (lower) head region
VZ branching region
V1 first cooling channel group
V2 further cooling channel group
AB outer region
MB middle region
IB inner region
AU outer circumference of the stator
IU inner circumference of the stator
\dot{V}ᵢₙ inlet volume flow
\dot{V}₁₋ᵢₙ inlet volume flow of the first cooling channel group
\dot{V}₂₋ᵢₙ inlet volume flow of the further cooling channel group
\dot{V}ₒᵤₜ outlet volume flow of the first cooling channel group
\dot{V}₁₋ₒᵤₜ outlet volume flow of the further cooling channel group
\dot{V}₂₋ₒᵤₜ outlet volume flow rate

1. Stator for an electrical machine, which has a stator core with at least one stator groove in which at least two electrical conductors are arranged,
wherein at least a part of the stator is produced by means of a method for additive manufacturing,
wherein for a predetermined number of the electrical conductors in each case at least one cooling channel which can be supplied with a cooling fluid is formed;
wherein at least two cooling channels, which are not formed by the same electrical conductor, are fluidically connected in parallel; and/or
wherein at least a first and a further cooling channel group, in each of which the cooling channels of several electrical conductors can be supplied with cooling fluid in parallel to each another, are fluidically connected in series and/or in parallel to form separate circuits or one circuit.

2. Stator of claim 1,
wherein the predetermined number of electrical conductors in which a cooling channel is formed; is less than or equal to a number of conductors in the at least one stator groove.

3. Stator of claim 1,
wherein the electrical conductors of a stator groove are arranged in a cross-section of the stator in a radial direction of the stator,
wherein the electrical conductors, which are arranged in an inner region relative to the radial direction of the stator, are formed with cooling channels.

4. Stator of claim 3,
wherein the electrical conductors, which are arranged in an outer region in relation to the radial direction of the stator and/or in a middle region between the outer and the inner region, are formed with cooling channels.

5. Stator of claim 1,
wherein the electrical conductors formed with at least one cooling channel are formed as hollow channel conductors, the cooling channel of which extends along a longitudinal direction of the electrical conductor, wherein the hollow channel conductors have a rectangular or polygonal cross-section with a circular, rectangular or polygonal cross-section of the cooling channel.

6. Stator of claim 1,
wherein the electrical conductors formed with a cooling channel each have a cooling channel element which forms the cooling channel and can be supplied with cooling fluid.

7. Stator of claim 6,
wherein the cooling channel elements are at least partially, enclosed by the respective electrical conductor in an active region of the stator.

8. Stator of claim 6,
wherein the cooling channel elements in a first and a second head region of the stator are at least partially enclosed by the respective electrical conductor.

9. Stator of claim 6,
wherein the cooling channel elements and the associated electrical conductors branch out in the first and in the second head region of the stator.

10. Stator of claim 9,
wherein each cooling channel element can be fluidically coupled at a first end in the first head region and at a second end in the second head region by a connecting element.

11. Stator of claim 1,
wherein the cooling channel element associated with an electrical conductor is arranged next to the electrical conductor, so that at least a part of a wall of the cooling channel element adjoins the associated electrical conductor.

12. Stator of claim 11,
wherein the cooling channel element associated with an electrical conductor is additionally arranged next to a neighbouring electrical conductor, so that at least a part of the wall of the cooling channel element adjoins the associated electrical conductor and the neighbouring electrical conductor.

13. Stator of claim 1,
wherein the cooling channels of the first cooling channel group and the further cooling channel group are connected in parallel within the groups, wherein the first cooling channel group is connected in series with the further cooling channel group, so that an inlet volume flow and an outlet volume flow are connected to form a cooling circuit.

14. Stator of claim 1,
wherein the ratio between the predetermined number of conductors, in each of which at least one cooling channel which can be supplied with a cooling fluid is formed, and a number of conductors in the at least one stator groove is ¼ or at most of ¼.

15. Stator of claim 1,
wherein the cooling channels are distributed over the electrical conductors such that one cooling channel is provided in an inner region relative to a radial direction of the stator, two cooling channels are provided in a middle region relative to the radial direction of the stator and one cooling channel is provided in an outer region relative to the radial direction of the stator, wherein the outer region adjoins the middle region in the direction of an outer circumference of the stator, wherein the outer region comprises two electrical conductors.

16. Stator of claim 1,
wherein the cooling channels are distributed over the electrical conductors such that the electrical conductors are provided alternately with a cooling channel and without a cooling channel or not with a cooling channel in the radial direction of the stator from an inner circumference to an outer circumference of the stator, wherein the innermost electrical conductor in an inner region is provided with a cooling channel with respect to the radial direction of the stator.

17. Stator of claim 1, wherein at least one winding head of the stator is additively applied to a non-additively produced stator core or active region of the stator.

18. Stator of claim 1,
wherein at least one connecting element of at least one cooling channel element is produced by means of the method for additive manufacturing, wherein the at least one connecting element is produced in a manufacturing or production step together with at least one winding head of the stator and/or at least one electrical conductor by means of the method for additive manufacturing.

19. Stator of claim 1,
wherein at least one winding head of the stator is additively applied to a stator core or active region of the stator.

20. Stator of claim 1,
wherein at least one winding head of the stator comprises at least one connecting element for at least one cooling channel element.

21. Stator of claim 1,
wherein the additive manufacturing takes place by applying build-up material layer by layer by a selective solidification of the build-up material by means of a beam impinging thereon.

22. Stator of claim 1,
wherein aluminium materials or aluminium powder, copper materials or copper powder, are used as raw or build-up material for the additive manufacturing, wherein the copper materials used or the copper powder have a purity of more than 99.5%.

23. Electric machine for electrically or hybrid-electrically driven vehicle, comprising a stator of claim 1 and a rotor.

24. Stator cooling system, comprising:
an electric machine;
a cooling unit which is fluidically coupled to the cooling channels of the electrical conductors of the stator of claim 1 such that the first and the further cooling channel groups are fluidically connected in series and/or in parallel to form separate circuits or one circuit,
wherein the cooling unit is further designed to supply the circuits or the circuit with a cooling fluid.

25. Stator of claim 14, further comprising:
a sensor unit designed to detect at least one temperature of the electrical conductors of the stator;
a control unit which is communicatively connected to the sensor unit and the cooling unit and is designed to control the cooling unit in such a way that the temperature of the electrical conductors of the stator below a predetermined lower limit temperature or above a predetermined upper limit temperature, is approached to a set-point temperature.

26. Method for cooling the electrical conductors of the stator of claim 1, wherein at least one temperature of the electrical conductors of the stator is detected, and
wherein the circuit or circuits which is/are formed by the cooling channels are supplied with a cooling fluid in such a way that the temperature of the electrical conductors of the stator below a predetermined lower limit temperature or above a predetermined upper limit temperature, is approached to a set-point temperature.
